(19) United States
(12) Patent Application Publication
(10) Pub. No.: US 2009/0009192 A1
(43) Pub. Date: Jan. 8, 2009

(54) System and Method For Package Inspection

(75) Inventors: Desmond Farrelly, Dublin (IE); Thomas Campbell, Dublin (IE)

Correspondence Address: CROMPTON, SEAGER & TUFTE, LLC, 1221 NICOLLET AVENUE, SUITE 800, MINNEAPOLIS, MN, 55403-2420, US

(73) Assignee: RECONCILE RESEARCH LIMITED, Dublin (IE)

(21) Appl. No.: 10/599,231

(22) PCT Filed: Mar. 26, 2004
(86) PCT No.: PCT/IE2004/000046

§ 371 Date: Sep. 17, 2008

(51) Int. Cl. G01N 27/22

(52) U.S. Cl. 324/663

(57) ABSTRACT

A system are described in the field of automated packaging, relating to the inspection of packages (packaged product) in a production line. In particular, the invention addresses a number of problems with inspection systems of the prior art. One embodiment described provides a capacitor sensing inspection system (3) comprising a pair of capacitors (28, 29). The first capacitor (28) in use having a reference package (32) as a dielectric and the second capacitor (29) in use having a package (10) to be measured as a dielectric. The system has a measurement circuit (33) for providing a first indication when the capacitance of the first capacitor (28) is substantially greater than the capacitance of the second capacitor (29) and a second indication when the capacitance of the first capacitor (28) is substantially less than the capacitance of the second capacitor (29), the first and second indications being indicative of differences between the reference package (32) and the package (10) to be measured. The system further comprises a potentiometer (54) having a variable position for adjusting a balance point of the measurement.

### FIELD OF THE INVENTION

The present invention relates to the field of automated packing and more particularly to systems for inspecting packages (i.e. one or more packaged products) in a production line.

### BACKGROUND OF THE INVENTION

For efficiency, quality and/or cost reasons, the majority of manufactured products are packaged using automated or semi-automated machinery. It is commonplace to provide some form of quality product inspection on such packaged products. These quality inspections may include, for example, random manual checking by an operator. Ideally, product inspection should be performed automatically to maximise efficiency and throughput.

A variety of inspection systems are available which may be used to test the quality\integrity of packaged products. These inspection systems include electronic weighing machines, which can test to ensure that a product is the correct weight.

One particular application where quality assurance is important is in the packaging of optical discs. Optical discs may be used for recording sounds, images and/or data. Optical discs are more commonly referred to by names of particular varieties including compact discs (CDs) or digital video discs (DVD's).

Optical discs are generally packed into appropriate box-shaped cases formed of a plastics or similar material. In addition to the optical disc(s), paperwork, trays and inlay cards are also packed together to provide an optical disc package.

Typically, the optical disc packaging operation is performed by means of a packing machine operating in a substantially automatic manner, save for an operator feeding the machine with all consumable materials, i.e. cases, optical discs, trays and associated paperwork. Typically, these packing machines can pack optical disk packages at a rate of 50-100 parts per minute depending on the particular machine.

Whilst these automated packing machines are very efficient, the combination of speed, mechanical handling, human handling and fragile product inevitably causes mistakes\damage in the packaged product. Such mistakes might include piece parts missing, damaged, misplaced, wrongly orientated, of the wrong type and wrongly packed quantities. If these damaged products are not detected, it can lead to customer dissatisfaction and increased customer relation costs from having to replace damaged product. It would be preferable if damage/mistakes in the packages could be detected at the production facility in an automatic fashion and prior to shipping.

A number of inspection systems are available for this purpose. One example of an inspection system, which is suitable for optical disc packages is the Mediasense JV500 supplied by Xiris Automation Inc. of Burlington, Canada. This system uses a sophisticated two or three camera arrangement in combination with advanced artificial intelligence image recognition software to confirm the presence and orientation of visible printed matter. Thus, the system can readily identify a significant number of typical mistakes in packaged optical discs. Unfortunately, this kind of system is extremely expensive, complicated and limited to external inspection of products. The system cannot identify missing, duplicated or damaged optical discs. The system is also not suitable for identifying when multiple paper items (such as inlay cards\booklets) are inserted in a package.

Another example of an inspection system uses a (three plate) twin capacitor system. In use, the capacitance of a reference capacitor is compared with that of a measurement capacitor. In the case of a packaging inspection system, a reference package containing an example of a good product (e.g. as might be determined by a visual inspection) is provided between the plates of the reference capacitor and acts as a dielectric for the reference capacitor. As packages are to be tested, they are positioned between the plates of the measurement capacitor, for example by a conveyor mechanism. If a significant difference in capacitance is detected between the two capacitors, it indicates that there is a flaw in the packaged product. Typically, the inspection system provides two outputs, the first output indicating when the capacitance of the reference capacitor is greater than that of the measurement capacitor and the second output indicating when the capacitance of the reference capacitor is less than that of the measurement capacitor. A margin of error is built into the inspection system to ignore differences in capacitance of less than a certain amount. An example of such a system is available from Rechner Industrie-Elektronik GmbH, of Lampertheim, Germany and is described in detail in EP1164380.

Under stable conditions these capacitive inspection systems may be used to detect the absence of an optical disc or paperwork from packaging. However, a significant disadvantage of these systems is that their characteristics change significantly with temperature and humidity thereby necessitating regular technician intervention to re-calibrate them. In addition, it is a generally a requirement of these systems that the reference and measurement capacitors be positioned close together. A further disadvantage of these systems is that they cannot be used to reliably identify wrongly inserted paperwork.

There is therefore a need for an inspection system and method that can be used in the inspection of a packaged product.

### SUMMARY OF THE INVENTION

Accordingly, the present invention provides inspection systems for use in assessing the quality and integrity of a packaged product. In accordance with a first embodiment of the invention a capacitor sensing inspection system is provided. The capacitor sensing system comprises a pair of capacitors. The first capacitor uses a reference package as a dielectric and the second capacitor uses a package to be measured as a dielectric. The capacitor sensing system has a measurement circuit for providing a first indication when the capacitance of the first capacitor is substantially greater than the capacitance of the second capacitor and a second indication when the capacitance of the first capacitor is substantially less than the capacitance of the second capacitor. The capacitor sensing system further comprises a potentiometer having a variable position for adjusting the balance point of the measurement circuit. The capacitor system also comprises an auto-balancer for controlling the balance point, wherein upon activation of the auto-balancer, the auto-balancer is adapted to move the potentiometer into a first position where the first indication is received from the measurement circuit and to move the potentiometer into a second position where a second indication is received from the measurement circuit, the auto-balancer being further adapted to then move the potentiometer position into a position substantially midway between said first and second positions. The activation of the autobalance system may be by means of a user operable switch. The auto-balancer may comprise a motor coupled to the potentiometer for moving the potentiometer between the first and second positions. Suitably, the capacitor sensing system may be used in an optical disc inspection system.

A second embodiment of the invention provides an inspection system comprising a transport mechanism for moving at least one package from a start point towards an end point, a stop movable between an inactivate position and an activate position, wherein in the activate position the stop prevents the progress of items along the conveyor belt and a control system responsive to a user input to place said inspection system in a teach mode. Upon receipt of the user input, the control system activates the stop. The system conducts the steps required in teach mode whereupon the control system causes the stop to move to the inactive position. Suitably, the control system may be adapted to stop the transport mechanism in response to the user input. The control system may be adapted to delay the stopping of the transport mechanism in response to the user input. Suitably, the transport mechanism comprises a conveyor belt system, desirably a twin belt conveyor. The axis of motion of the stop may be substantially perpendicular to the direction of travel of the conveyor. Suitably, in the deactivated position, the stop rests below and between the belts of a twin belt conveyor system.

In a third embodiment of the invention, an inspection system is provided for inspecting at least one package as it moves along a conveyor belt. The inspection system comprises a capacitor sensing system having a pair of capacitors. The first capacitor uses a reference package as a dielectric. The second capacitor is disposed about the longitudinal axis of the conveyer belt such that a package moving along the conveyor may act as a dielectric between the plates of the second capacitor. The first capacitor may be positioned remotely from said conveyer belt. For example, the first capacitor may be located in a control panel enclosure of the inspection system. An opening or aperture may be provided in the control panel enclosure so as to define a slot for receiving the reference package between the plates of the reference package capactitor. In one configuration, the plates of the first capacitor are disposed on opposing sides (left and right) of the slot or above and below the slot. In this way a package may be inserted through the slot between the plates. In order to retrieve the reference package from the enclosure, an actuator may be provided for ejecting a reference package through the slot opening.

In another embodiment of the invention, an inspection system for inlay cards in optical disk packages is provided comprising a transport mechanism for moving at least one optical disk package along a longitudinal axis. A first sensor is provided for identifying the arrival of an optical disk package at a test location along the longitudinal axis. A second sensor is disposed about this test location. The second sensor is a light sensitive sensor having an associated light source. The light sensitive sensor and associated light source are positioned on opposing sides of the transport mechanism along an axis, which is inclined relative to the longitudinal axis of the transport mechanism. The second sensor is positioned to provide an indication of the presence of an inlay card in an optical disk package when the first sensor identifies the arrival of an optical disk package. This indication is obtained from the detection (or non detection) of light by the second sensor from the light source, i.e. if an inlay card is present light will not pass through the optical disk package. The optical disc inspection system may further comprise a capacitive sensing arrangement for detecting the presence of one or more optical discs in an optical disc package. Similarly, the optical disc inspection system may comprise a colour/pattern recognition sensor for testing the correct presence of printed matter on the top and/or bottom surface of a package.

In yet another embodiment, an inspection system for packaged goods is provided comprising a first pattern\colour recognition sensor which, in use, is adapted to indicate the presence of a reference pattern\colour in a package, and a capacitor sensing system for comparing the capacitance of a pair of capacitors and to provide an indication when the capacitances are not substantially the same, the first capacitor of the pair having, in use, a reference package as a dielectric, and the second capacitor of the pair having, in use, the package to be tested as a dielectric, wherein the first pattern\colour recognition sensor is used to indicate the correct presence of printed matter on one side of the package and the capacitor sensing system is used to indicate the correct contents in a package. The inspection system may further comprise a second pattern\colour recognition sensor which, in use, is adapted to indicate the presence of a reference pattern\colour on the opposite side of the package to the first sensor to indicate the correct presence of printed matter on that side of the package.

In yet another embodiment, an inspection system for packaged goods is provided comprising a first sensor for detecting the arrival of a packaged good in a test location, a second sensor disposed about the test location and configured to provide a continuous output representing a pass or fail status for the contents of the test location, output means adapted to provide an output indicative of the output of the second sensor in response to the detection by the first sensor of the arrival of the packaged good in the test location, and wherein the output means is adapted to provide an immediate pass output if a pass status is provided by the second sensor and in the event of a fail status is further adapted to continue to test for a pass status from the second sensor for a first delay time.

The output means may be adapted to provide a fail output when said first delay time has elapsed and no pass status was detected from the second sensor during the delay time period.

The second sensor may be a colour/pattern recognition sensor. The second sensor may also be a capacitive sensing arrangement adapted to enable a comparison of the capacitance of a reference capacitor with a measurement capacitor.

The inspection system may further comprise a third sensor disposed about the test location and configured to provide a continuous output representing a pass or fail status for the contents of the test location, wherein the output means is adapted to provide an output indicative of the output of the third sensor in response to the detection by the first sensor of the arrival of the packaged good in the test location, wherein the output means is adapted to provide an immediate pass output if a pass status is provided by the third sensor and in the event of a fail status is further adapted to continue to test for a pass status from the third sensor for a second delay time.

The first and second delay times may be different. The advantage of this approach is that different sensitivities may be applied depending on delay times. The inspection system may comprise a sensitivity adjustment means which alters the effective sensitivity of the second sensor by altering the first delay time.

In yet another embodiment, a discard mechanism for a conveyor belt system for moving at least one package from a start point towards an end point along a longitudinal axis is provided, the conveyer belt system comprising a first belt located adjacent to a first edge of the conveyer belt system and a second belt located adjacent to an opposing edge of the conveyer belt system, wherein said first and second belts co-operate to move the at least one package towards the end point, the discard mechanism comprising:

an opening for receiving a package, the opening being positioned between the first and second belts,
an arm movable between a rest position external to the conveyor belt system and an active position, such that when the discard mechanism is activated, the arm is moved from the rest position to the active position thereby displacing one of the at least one packages from one of the belts, thus allowing the package to fall through the opening.

The arm of the discard mechanism may be movable along an axis transverse to the longitudinal axis. Suitably, the rest position is adjacent to an external edge of one of the belts. The active position may be adjacent to the internal edge of one of the belts, suitably over the opening.

An inclined surface may be provided on the opposite side of the conveyer belt system to the movable arm so that as an edge of an package is displaced by the movable arm, an opposing edge of the item moves along the inclined edge. The movable arm may have application means mounted thereon for providing a downward force on a package item to assist the downward fall of the package through the opening. This application means for providing a downward force may comprise an air blower. The discard mechanism may comprise a sensor for detecting the arrival of a package to be discarded.

Moreover, it will be appreciated that the various elements of the overall system may be combined in several different combinations to produce an individual system. Thus the discard mechanism may be combined with any of the test systems.

### BRIEF DESCRIPTION OF THE DRAWINGS

The present invention will now be described with reference to the accompanying drawings in which:

FIG. 1 is a block diagram of a system according to the invention,

FIG. 2 is a simplified top view of a transport mechanism in a system according to the invention,

FIG. 3 is a rear side view of a sensor arrangement around a test location according to one aspect of the present invention,

FIG. 4 is a schematic diagram of a capacitive sensing circuit for use with the present invention,

FIG. 5 is a side view of an auto-balancer according to the invention for use with the circuit of FIG. 4,

FIG. 6 is a flowchart illustrating a method of operation for the auto-balancer of FIG. 5,

FIG. 7, is a simplified top view of a discard mechanism according to a further aspect of the invention,

FIG. 8, is a cross sectional view of the discard mechanism taken along AA of FIG. 7,

FIG. 9 is a flowchart for a teach function according to another aspect of the present invention,

### DETAILED DESCRIPTION OF THE DRAWINGS

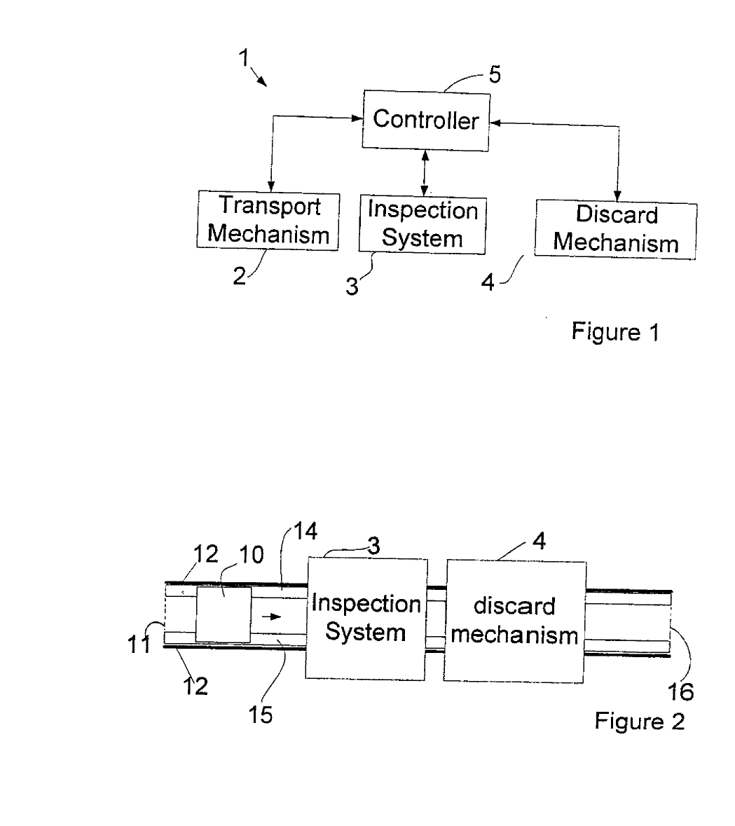

An exemplary package inspection system 1 according to the invention, as shown in schematic form in FIG. 1, comprises a transport mechanism 2, an inspection system 3, a controller 5 and a discard mechanism 4.

The function of the transport mechanism 2, which is illustrated in FIG. 2, is to move a package 10 from an entry point 11 through to an exit point 16. The entry point may be coincident with an exit point of an adjacent part of a production line, for example the end of a conveyor belt exiting from a packing machine. Similarly, the exit point of the transport mechanism may be positioned so that packages are passed to the next stage in the production line, for example a wrapping machine.

Suitably, the transport mechanism is a belt conveyor. For reasons which will become apparent from the description below, the belt conveyor preferably comprises a twin belt conveyor mechanism. In the twin belt conveyor, a first belt 14 is located adjacent to a first edge of the conveyer belt mechanism and a second belt 15 is located adjacent to an opposing edge of the conveyer belt mechanism. The first and second belts 14,15 co-operate with one another to move packages from the entry point towards the exit point through the inspection system 3 and the discard mechanism 4. The conveyor belts 14,15 are suitably driven for example by one or more electric motors, which may be integrally formed within the conveyor belt mechanism or externally mounted thereto. The operation of the electric motor may be controlled by the controller 5 to effectively switch on or off the conveyor. One or more guides 12 may be provided along the outer edges of the conveyor belt to ensure packages do not fall off the conveyor belt.

The inspection system 3, which will be described in greater detail below, examines individual packages as they move along the conveyor 2. The inspection system provides one or more signals to the controller. These signals indicate the conformity of an inspected package with a standard package or control package. The controller in turn makes a determination from the received signals as to whether a package should be discarded or allowed to pass to the exit point along the transport mechanism. When a package is to be discarded, the controller actuates the discard mechanism 4. The discard mechanism separates packages which have passed inspection from those which have failed inspection. Only packages which have passed inspection are allowed to proceed along the conveyor 2 to the exit point 16. Packages which have failed inspection are routed to an alternative exit. A variety of discard mechanisms are known, including for example air blower mechanisms for sending packages sideways off a conveyer belt or upstackers that lift packages up from the conveyor belt. These discard mechanisms do however occupy a considerable amount of space and may be prone to jamming along with other problems. Another known discard mechanism is to have an exit to bin feature at the end of the conveyor belt system. This, however, can introduce problems because of the delay between a faulty package being detected and its arrival at the end of the conveyor system. A particularly advantageous discard mechanism in accordance with the present invention will be described in greater detail below.

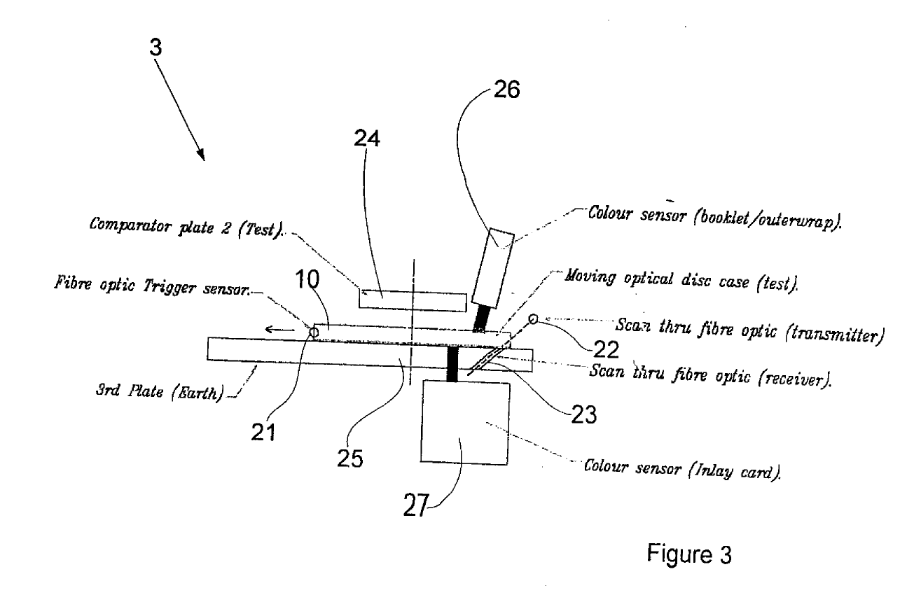

The inspection system will now be described in greater detail, with reference to the exemplary arrangements shown in FIG. 3. It will be appreciated that the transport mechanism which is shown in FIG. 1 as block 2, and is preferably a conveyor transports packages through the inspection system. The inspection system includes a first sensor 21, for example a fibre optic trigger sensor, is provided adjacent to the conveyor. This first sensor detects the arrival of a package 10 in a test location. The test location is the area where the inspection system performs its tests on the integrity of a package. The inspection system may have more than one test location. The first sensor 21 provides a signal to the controller 5 (shown in FIG. 1) when a package enters the test location.

A known difficulty with prior art optical disc inspection systems is that the only method for detecting improperly inserted inlay cards relies upon expensive camera systems. The present invention provides a relatively inexpensive method of detecting an improperly inserted inlay card. This method uses the first sensor 21 to detect the arrival of an optical disc package into the test location, in response to which the controller 5 checks the output from a second sensor 23. This second sensor 23 is used to detect the correct positioning of an inlay card. This second sensor may be a light sensitive sensor, for example a scan thru fibre optic receiver 23 having an associated light source 24, for example a scan thru fibre optic transmitter. The second sensor and its light source are arranged along an axis which is inclined with respect to the longitudinal axis of the transport mechanism, such that packages moving along the transport mechanism interrupt the path between the second sensor and its associated light source. The sensor-light source arrangement is suitably inclined at an angle of between 35 and 45 degrees, preferably about 40 degrees to the transport mechanism. In the exemplary arrangement shown in FIG. 3, the second sensor is positioned below the transport mechanism and the associated light source is positioned above the transport mechanism. It will be appreciated that an aperture will be required in the transport mechanism to provide a path between the second sensor and the light source. The use of a twin belt conveyor for the transport mechanism 2 readily facilitates the provision of an aperture in the path between the second sensor and the light source. At the test location, the path of light from the light source to the sensor is through the end of the optical disk package exiting through the bottom of an optical disc package. If an inlay card is missing or misplaced in the package, then the light will pass through the optical disk package (as the optical disc package is typically a transparent plastics material). If light is detected by the second sensor as it enters the test location, it indicates a product failure, e.g. from a missing or improperly placed inlay card. If, however, no light is detected by the second sensor, it indicates the inlay card is in the correct position and the sensor will provide a signal to indicate the product has passed. It will be appreciated that the second sensors output is only recognised as valid at the instant a package arrives into the test location.

The type of sensors which may be used to detect the presence of the inlay card are relatively inexpensive, yet they provide a simple solution to the known difficulties with prior art optical disc inspection systems and overcomes the necessity to use expensive camera systems for detecting improperly inserted inlay cards.

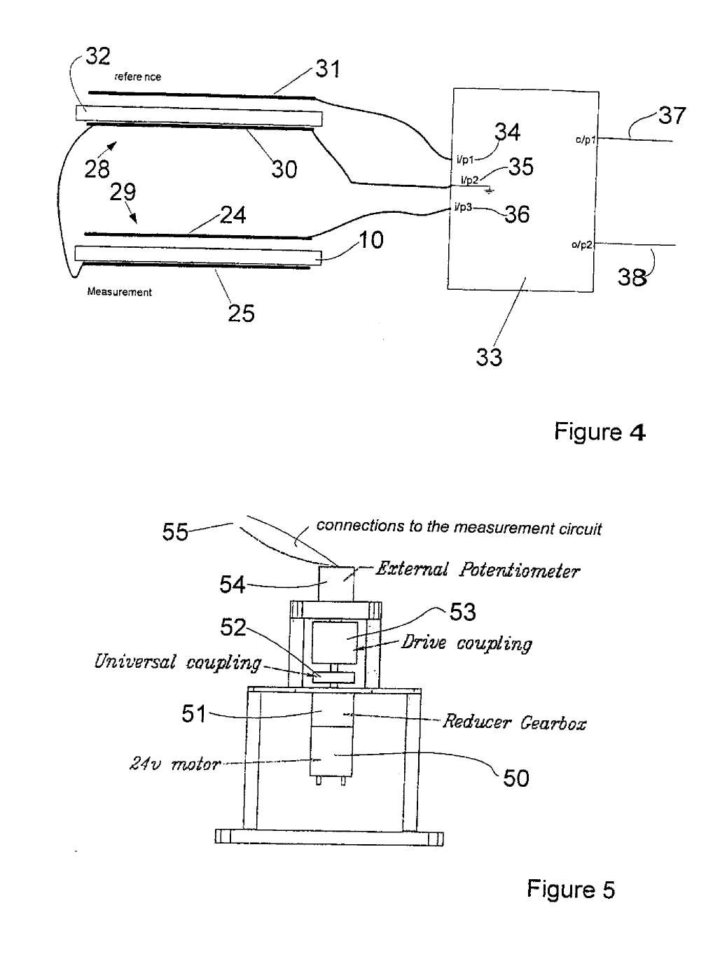

The inspection system may additionally comprise a capacitance sensing system of the type described previously in reference to the prior art. The sensing system, as illustrated in FIG. 4, comprises a pair of capacitors 28,29; the first capacitor 28 is a reference capacitor and the second capacitor 29 is a measurement capacitor. The first capacitor uses a reference package 32 as a dielectric, i.e. the reference package is positioned between the plates 30,31 of the reference capacitor 28. A reference package is one which has been manually inspected and passed by an operator, which may then be used as a reference for comparison with subsequent packages. The second capacitor is a test capacitor in which a package 10 to be tested is positioned as a dielectric between the plates 24, 25 of the second capacitor (as shown in FIG. 3). In the exemplary arrangement of the testing system, the plates 24,25 of the test capacitor are positioned between the belts of the twin belt conveyor in the test location (described previously). One plate 24 of the test capacitor is positioned above the conveyor and the other plate 25 just below the level of the conveyor belt. Accordingly, as a package 10 is moved into the test location by the conveyor it acts as a dielectric for the test capacitor. In practise, one plate 25 (the ground plate) of the measurement capacitor will be electrically tied to a (ground) plate 30 of the reference capacitor and also to ground. The two other (sensing) plates 31, 24 may be smaller than these ground plates 25, 30. The ground plates 25, 30 may in fact be integrated within the structure of the system, since they merely provide a uniform ground plane. The sensing plates 31, 24 may for example be sensing plates available under part number KSL-5-1-CD-75 from Rechner Industrie-Elektronik GmbH.

A measurement circuit 33 is provided to compare the capacitance of the test and measurement capacitors 28,29. One exemplary measurement circuit is the KSLA-8-CD-PNP-3β available from Rechner Systems. The measurement system uses electrical connections with the plates of the capacitors as inputs 34,35,36 and preferably provides two outputs 37,38. The first output 37 provides an indication when the capacitance of the reference capacitor 28 is greater than the capacitance of the test capacitor 29. The second output 38 provides an indication when the capacitance of the reference capacitor is less than the capacitance of the test capacitor. It will be appreciated that the measurement system includes some hysteresis functionality. It will thus be appreciated that the terms less than and greater than are intended to include a small tolerance so that when the capacitances of the two capacitors are similar there is no output from either the greater than or less than outputs. This means that there is a small range when neither the first or second output provides an indication. Typically, measurement circuits of the type described allow for manual tuning by a trained technician. For example, in the case of the exemplary measurement circuit from Rechner Systems, a symmetry potentiometer is provided which is adjustable using a small screwdriver to adjust the operating balance point of the amplifier.

The first and second outputs 37,38 may be connected directly as inputs to the controller 5, which then decides whether to pass or fail the package being tested, i.e. if a first or second output provides an indication that the capacitance of the test capacitor is less than or greater than the capacitance of the reference capacitor, the controller operates the discard mechanism 4 to discard the tested package 10.

The capacitive sensing system in combination with the first and second sensor arrangement previously described, provides a solution to several problems associated with the prior art, including the inability of capacitive sensing systems to identify wrongly inserted product without overly increasing the sensitivity of the capacitive system (the problems of which are discussed below). Thus, the two-sensor combination described for detecting the presence of an inlay card may be viewed as a means for increasing the effective sensitivity of the capacitance measurement system without altering the actual sensitivity of the measurement system.

Although, the capacitor sensing system is useful for detecting the presence or otherwise of optical discs or other items in a packaging, it cannot distinguish between different printed matter, i.e. it cannot distinguish between a yellow coloured inlay and a red coloured inlay card. It should be noted that this factor may not be an important concern from a packager's perspective as the number of overall errors of this type may be small. Prior art camera system of the type described above with reference to the prior art, may be used to detect the correct presence of the printed matter. However as discussed, they are overly expensive and complicated.

The inventors of the present system have realised that instead of performing complicated comparisons of the whole image of an inlay card/booklet as performed by the prior art camera systems, it is possible to simply test a small area of the printed matter for a particular pattern or colour. Relatively, low cost sensors are readily available for this purpose. This, in combination with the described two-sensor arrangement which indicates the correct position of an inlay card, provides a reliable indication as to the presence in the correct position of the correct inlay card and/or booklet. In practise, two pattern\colours sensors are provided on an inspection system. The first sensor 26 tests the printed matter on the top of the package, which in the case of an optical disk package may be the booklet\outerwrap. The second sensor 27 tests the printed matter on the underside of the package (which in the case of an optical disk package may be the inlay card). Examples of such colour sensors would include FT50C-1-PSLB from SensoPart Industriesen GmbH, Wieden Germany. Other suppliers would include Baumer Electric of Frauenfeld, Switzerland.

These sensors may be taught a reference pattern\colour by placing a reference image in front of the sensor (i.e. positioning a reference package in the test location) and applying a control signal to an input of the sensor. In the present system, the controller applies such a control signal when the system is placed in a teach mode (explained below) and a reference package is positioned in the test location. Another advantage of these colour\pattern recognition sensors is that they are self contained, in the sense that no external processors/systems are required to determine the result (as in the case of the camera systems). Each sensor 26,27 simply provides a continuous logic signal to the controller indicating whether the material being presented to them matches the characteristics of a stored colour/pattern.

The inventors of the present invention have further realised that a significant problem with prior art detection systems, particularly capacitor sensing systems, is that they are overly sensitive and not suitable for the tolerances required in a production environment. This sensitivity becomes apparent as the temperature and/or humidity of the production line change. Thus whilst an inspection machine may operate reliably in the morning (after calibration by a technician), it characteristics may change as the day progresses leading to increased rejection of good packages. This problem may be reduced through the use of air conditioning. Unfortunately, air conditioning is not an inexpensive or sometimes practical solution. Another problem with sensitivity is that even if the temperature\humidity conditions are stable, and the inspection apparatus is properly calibrated to ensure the quiescent point of the system is properly set to minimise sensitivity, the product being tested may change (which from a test perspective means replacing the reference package with another reference package). The replaced product may have a different quiescent point, potentially necessitating the presence of a trained technician (not often a practical reality in low cost high volume production facilities) or acceptance of increased errors in the system. Moreover, a technician may not be able to necessarily determine the best adjustment possible.

Another problem arising from overly sensitive equipment is that the quality of the packaging itself may lead to products failing an inspection, even though the packages are perfectly fine. For example, in the case of CD jewel cases, they normally have rigid planar surfaces. In less expensive examples of CD jewel cases, the surfaces may be warped or flexed slightly during the production\packing process. This warping whilst not harmful to an optical disc contained within the package and not readily noticeable to a consumer leads to increased numbers of product being rejected by overly sensitive inspection systems.

However, simply decreasing the sensitivity of the detection systems does not solve the problem as it means that an increased number of defective products slip through the inspection system.

To overcome difficulties with sensitivity, the inventors have developed a number of methods, which may be used either in isolation or in combination to reduce the problems associated with system sensitivity (effectively altering the effective sensitivity without changing the actual sensitivity of the measurement circuit) without significantly increasing the number of defective products that may slip through the inspection system.

One method of adjusting the sensitivity uses the measurement circuit previously discussed, in which the measurement circuit is provided with a potentiometer (typically operated by a technician using a small screwdriver) for modifying the quiescent or balance point of the measurement circuit. The inventors have realised that for maximum efficiency of the system, the system should be adjusted so that the quiescent or balance point of the system is always midway between the points where indications are received from the first and second outputs 37,38 of the measurement circuit 33, i.e. so that the system is not overly sensitive in one direction or another. Whilst this task may be performed by a technician, it is generally not a precise method and requires continual adjustment as temperature, humidity and package type change.

Accordingly, the inventors have developed an auto-balancing system for controlling the potentiometer position to automatically adjust it so that the quiescent or balance point of the system is always midway between the points where indications are present on the first and second outputs 37,38. In this balancing system, a potentiometer which adjusts the quiescent or balance point of the measurement circuit is electronically controllable, in the exemplary embodiment shown in FIG. 5, by means of an electric motor 50 connected by a gearing and coupling arrangement 51, 52, 53 to the wiper of a conventional manual potentiometer 54. Suitably, the potentiometer is provided as an external potentiometer to the measurement circuit housing and connected thereto by suitable connections 55. Alternatively, the auto-balancing system may be integrated within the measurement circuit housing.

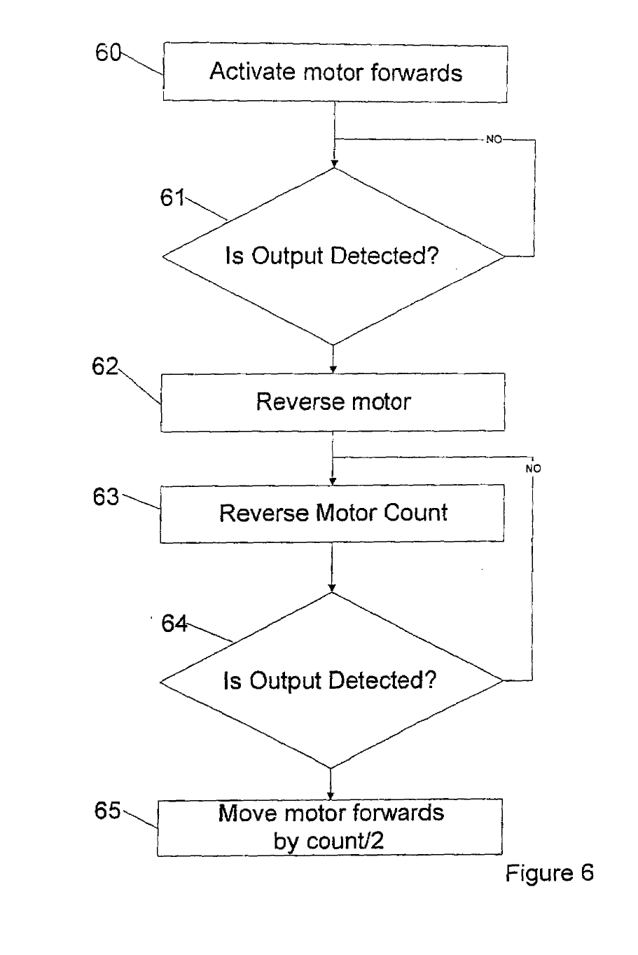

The operation of the auto-balancing system will now be described with reference to an exemplary method of operation. The method starts when the measurement system is placed into a teach mode (described in greater detail below). During such a teach mode a first reference package is inserted as a dielectric between the plates of the reference capacitor and a second reference package is inserted as a dielectric between the plates of the measurement capacitor. Once the packages have been inserted, the balancing system is activated by the controller. Upon activation, the balancing system, as illustrated in FIG. 6, is adapted to move the potentiometer into a first position where a first indication is received from the measurement circuit, e.g. the motor is rotated forward 60, until the measurement circuit indicates 61 that the capacitance of the reference capacitor is bigger than the that of the measurement capacitor. The balancing system then moves the potentiometer into a second position where a second indication is received from the measurement circuit, e.g. the motor is reversed 62 until the measurement circuit indicates 64 that the capacitance of the measurement capacitor is bigger than the capacitance of the reference capacitor.

In moving from the potentiometer from the first position to the second position, the balancing system measures 63 the distance between the two positions, for example by counting the time taken, or the number of pulses required to be applied to move the motor that distance.

The balancing system then moves the potentiometer position into a third position substantially midway between said first and second positions, e.g. by advancing 65 the motor half the count distance. This third point corresponds to the quiescent or balance point of the system for the packages presented to the measurement system during the teaching process and for the temperature and humidity conditions present at that time.

The activation of the auto-balance system may be by means of a user operable switch, so as to place the system in a teaching mode. As no specialist training or skills are required, this process may readily be applied by any operative following a minimum of training.

Although, this auto-balance system maximises the performance of the inspection system for any presented package, it does not totally eliminate the problems associated with warped packaging or like defects failing in an overly sensitive system.

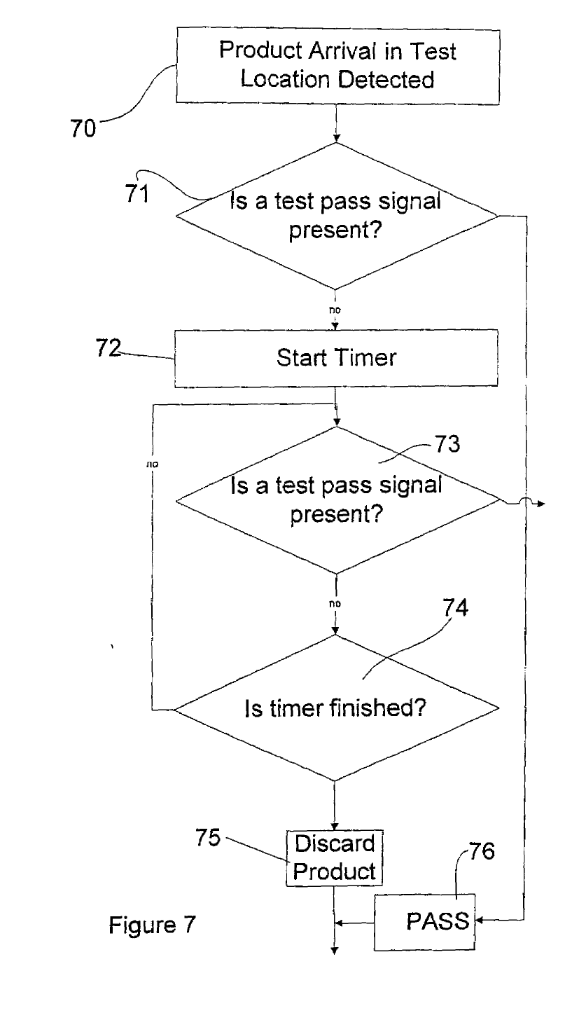

To overcome this problem, the inventors of the present invention have developed a new method of inspection, in which the product is continually tested for an extended period of time after it enters the test location, rather than the existing methods of instantaneous testing upon entering the test location. If any product pass indication is obtained at any time during this extended period of timer the product is passed. This extended period of time significantly reduces the number of packages that fail because of warped outer cases. In greater detail, the system uses a first sensor (as described previously) for detecting the arrival of a packaged good in a test location. A second sensor, which may be the colour sensor or the capacitor sensing system described above tests packages within the test location. This second sensor provides a continuous output representing a pass or fail status for the contents of the test location. In the case of the capacitive sensor, two outputs are provided. A suitable output means (e.g. software code in the controller 5 or as functional circuit implementing the method using a combination of logic and timing circuitry) is provided to monitor the output of the second sensor in response to the detection by the first sensor of the arrival of the packaged good in the test location. The method and manner of operation of the output means will now be explained with reference to the exemplary flowchart of FIG. 7. A first step is that upon detection 70 by the first sensor of the arrival of a package in the test location, the output means checks 71 to see if the output of the second sensor represents a pass status. The output means is adapted to provide an immediate pass output 76 if a pass status is provided by the second sensor upon the arrival of the packaged good in the test location.

If a pass status is not present the output means will continue to test 73 for a pass status from the second sensor for a fixed period of time, e.g. by starting a countdown timer 72 and testing until it expires 74. The output means will only provide a fail output, e.g. causing the product to be discarded 75, when the fixed time period has elapsed and no pass status has occurred in the intervening period since the arrival of the packaged good. It will be appreciated that the functionality of the output means may easily be implemented in a controller using appropriate software code by any skilled programmer in the art.

Where there are a number of sensors, e.g. the colour sensors, (the capacitor measurement system may also be regarded as two sensors since it provides two outputs), a separate (fixed) period of time may be used for each sensor. Having different periods of time for detecting a pass status from each status allows different sensitivities to be applied in software to different sensors without a need for manual adjustment of the sensors or their associated circuitry. Instead the time values may be set in software code. Furthermore, a series of different periods of time may be available for selection by a user. Thus a user may elect to set the inspection to a high or low sensitivity by selecting different periods of time for testing, thus the system may provide the operator with a button on a keypad for switching between a high and a low sensitivity mode. This may be useful where the inspection system is used for a plurality of different package types. For example, in the case of optical disc packages, the sensitivity may be set as high when each package only contains a single optical disk and set to low when they contain multiple optical discs.

A further problem with prior art package inspection systems is that, in order to teach an inspection system a new package, they require the transport mechanism to be switched off. An operator may then carefully place a reference package precisely in the test location, which is both time consuming, requires training and is prone to human error. Moreover with some machines, it may require the operator opening the inspection system itself. This is clearly an extremely unreliable and cumbersome process.

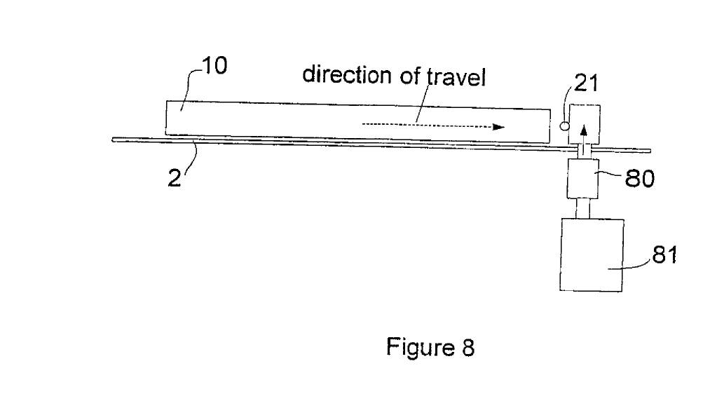

It is not however not a straightforward easy task to automate since, predicting the precise location of a product when a conveyor belt or other transport mechanism is stopped is not an easy task. Accordingly, the present inventors have provided a modified system in which said package positioning is automated. In particular, the system, as shown in FIG. 8, comprises a transport mechanism 2 (as described previously, e.g. a conveyor belt system). The conveyor belt as described previously moves packages as they are loaded at a start point towards an end point along a longitudinal axis. The modified system further comprises a stop 80. The stop is movable between an inactive position, which is located outside (e.g. above, below or to one side) of the path of packaged products along the transport mechanism, and an active position (shown in dotted outline), which is located in the path of packages 10 along the conveyor belt 2. In the active position the stop prevents the progress of packages along the conveyor belt. The stop is suitably positioned such that when a package abuts the stop in the active position, the package product is ideally positioned in the test location of the inspection system. Thus the user can be sure that if the product is abutting the stop 80 it is in the correct position for teaching the system. An actuator 81, for example an air operated piston, is provided to move the stop between the active and the inactive positions. The actuator 81 is controlled by the controller 5.

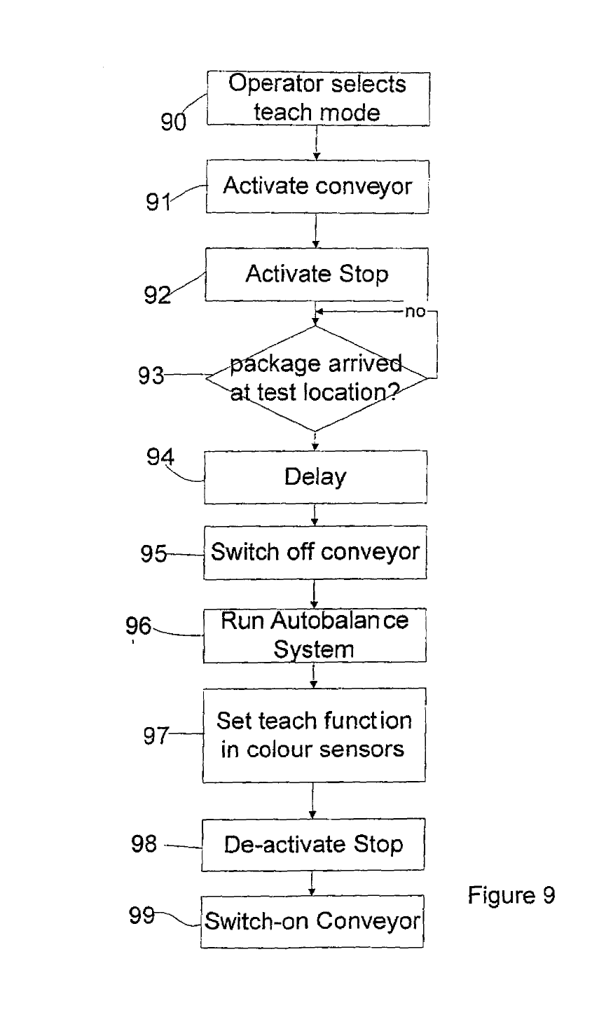

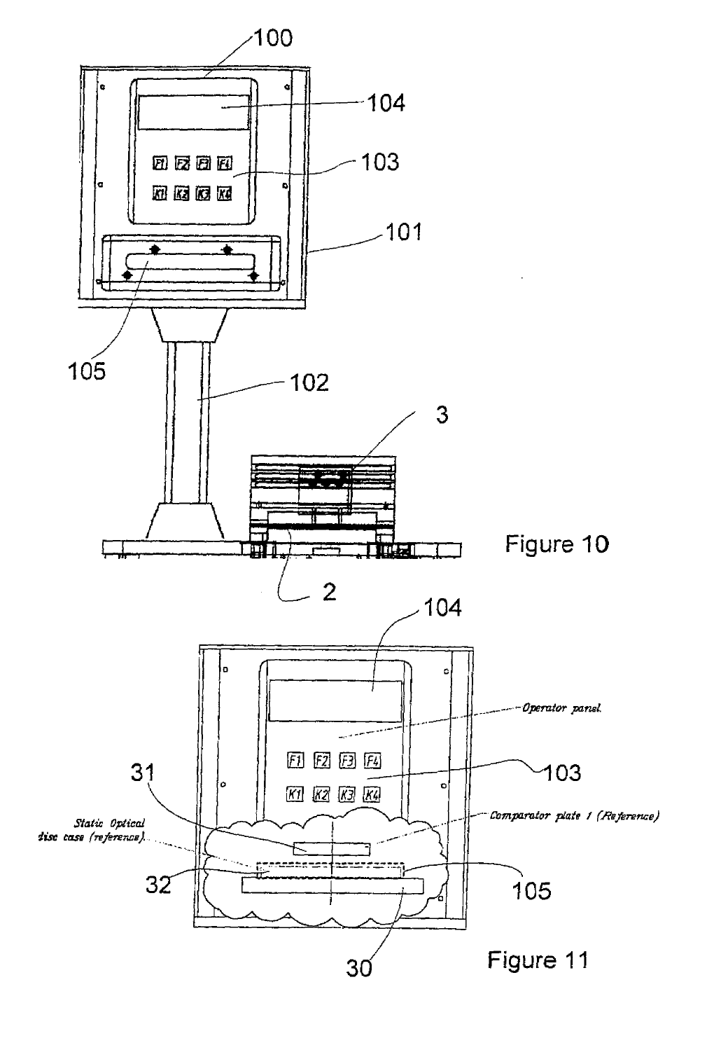

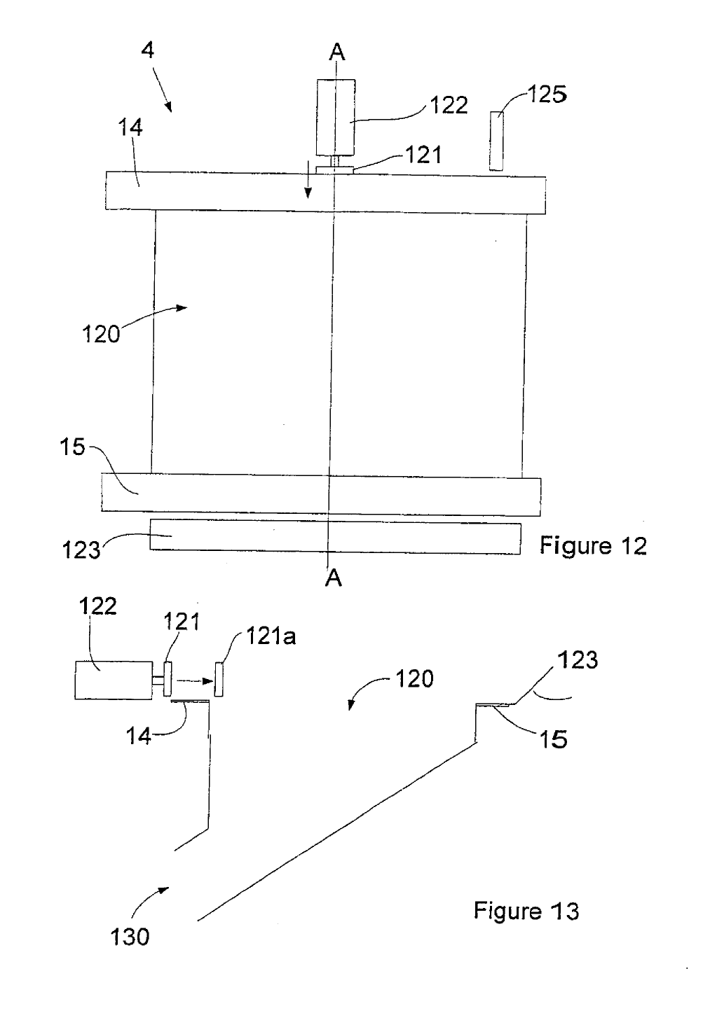

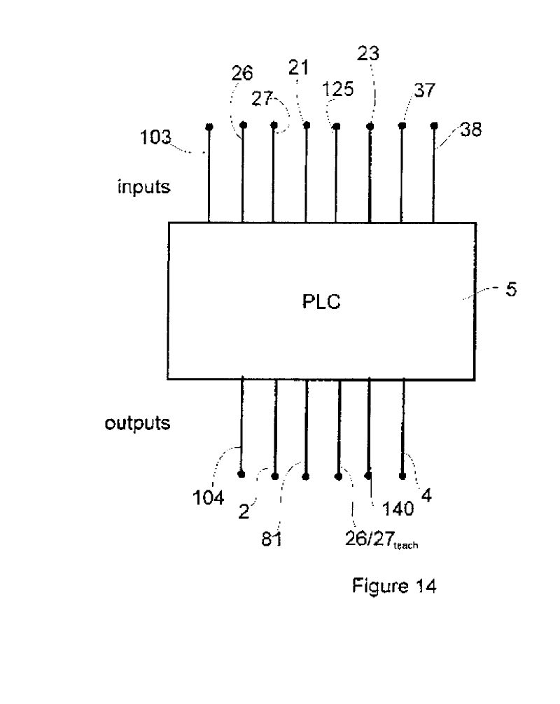

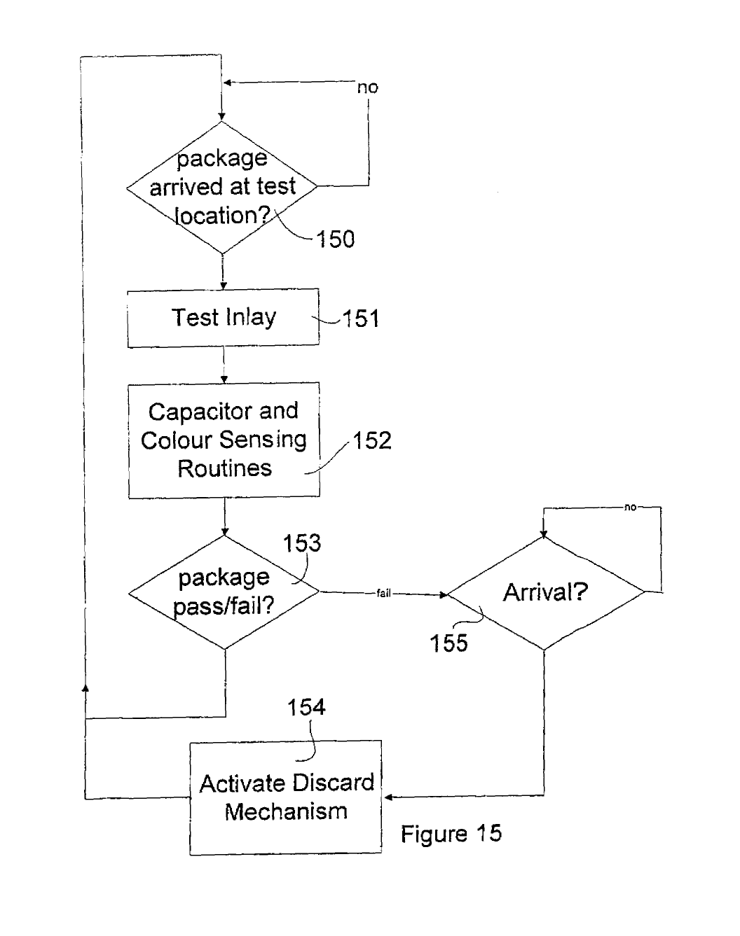

An exemplary method of operation of the stop will now be described with reference to FIG. 9. The method commences when the inspection system is placed 90 into a teach mode, for example in response to a user input. The controller 5 activates 92 the stop actuator 81 to move the stop into the active position and switches on 91 the conveyor. A user then introduces a package 10, which is to be used to teach the system, to the start point of the transport mechanism. As the package moves along the transport mechanism, its progress is halted by the stop member at the test location which is coincident with the sensing location. The sensor 21 detects 93 the arrival of the package 10 in the test location, in response to which the controller switches 95 the conveyor drive off, to ensure the product is stable during the teach process. To ensure the product is abutting the stop member, the conveyor drive is not switched off immediately, but instead is allowed to run for a short period of time (a delay 94). Thus if the packaged product bounces off the stop 80 (which is quite likely), the movement of the conveyor 2 brings it back to the stop. This delay 94 in switching the conveyor drive off ensures that the packaged product is correctly placed in the test position for the inspection system. A suitable delay is approximately ? msec.

Once the inspection system has performed all of the tests required during the teaching process, e.g. running the auto-balance function 96 previously described and/or the previously described colour sensors teach process 97, the controller activates 98 the actuator 81 to cause the stop 80 to return to its inactive position. The conveyor is then restarted 99 and the packaged product moved along to the exit of the conveyor.

Space on a production floor tends to be limited, accordingly it is advantageous if the size of any machinery used on the production floor can be minimised. The system of the present invention is designed to be small in size compared to prior art systems. The stop mechanism described previously reduces the space required by reducing the need for an operator to access the test location (i.e. to manually place the package in the test location). The inventors have further realised that a significant element of the space required in prior art patent systems is the necessity of having the reference and measurement capacitors positioned beside each other beside the conveyor belts.

As a first step in space saving and as shown in FIG. 10, the inventors have mounted the operator control panel 100, including a keypad 103 and a display 104 for the inspection system in an enclosure on an upright member 102 above the main body of the system comprising the conveyor 2, inspection system 3 and discard mechanism (not shown). This results in a space saving in the main body of the system. Moreover, the inventors have realised that a further space saving may be made by positioning the reference capacitor 28 of the capacitor sensing system in a position remote from test location and preferably also from the conveyor. The inventors have achieved this by mounting the plates 30,31 of the reference capacitor within an enclosure positioned above the transport mechanism. Suitably, this is the same enclosure 101 that houses the operator control panel 100. A slot 105 is provided defining an opening in the enclosure 101 for receiving a reference package 32. One plate 30 of the reference capacitor is disposed on one side of the opening (shown in dashed outline in FIG. 11) and the second plate 31 of the reference capacitor is disposed on the opposing side of the opening, so that when a package is inserted into the slot, the reference package is positioned between the two plates 30, 31 of the reference capacitor. Although, the slot and plates may be arranged along a vertical axis, it is preferable that the slot is arranged horizontally with one plate above the slot and one plate below the slot. A reference package may be inserted simply by sliding the package into the slot 105. For convenience, an actuation means, e.g. a small air, hydraulic, or electric piston (not shown), may be provided to eject a reference package 32 through the slot 105 when required by the operator, e.g. by pressing an associated button on the operator keypad.

Another element of prior art systems which generally takes a lot of space is the discard mechanism. The present system provides a particularly advantageous discard mechanism, illustrated in FIGS. 12 and 13, which is both fast and small in size.

The discard mechanism 4 is particularly suited and intended for use with a twin belt conveyer system, wherein two belts 14, 15 are located at opposing edges of the conveyer belt mechanism (as described previously).

An opening 120 is provided in the surface of the inspection system between the first and second belts 14, 15. This opening 120 extends between the inner edges of the first and second belts 14, 15 and is longer than the longest length of packaging used in the inspection system. An arm 121 is provided on the exterior side of one of the belts 14. This arm 121 is movable between a rest position external to the conveyor belt 14 and an active position 121a. The active position is between the two belts. In practise, the active position 121a is marginally beyond the inner edge of the belt. For example, if the belt 14 width is 10 mm, and the rest position is immediately adjacent to the belt then the travel distance between the rest position and the active position would be just over 10 mm (11-12 mm), i.e. sufficient to displace a product from the belt. The discard mechanism is activated by the controller in response to the inspection system. As the discard mechanism may be located a distance from the inspection system on the transport mechanism, a further sensor may be used to provide an indication to the controller that a package has arrived at the discard mechanism, whereupon, the controller would activate the discard mechanism. Upon activation, the arm of the discard mechanism is moved from the rest position to the active position thereby displacing the packaged product from one of the belts. Once displaced from the belt, the packaged product falls through the opening. A chute 130 may be provided below the opening to direct discarded products to a bin for subsequent examination, re-use or disposal.

For reasons of speed, the arm moves along an axis transverse to the longitudinal axis of the conveyor belt, thus minimizing the travel distance of the arm. Suitably, an actuator 122, e.g. an air operated piston, is provided to move said arm between the rest and active positions. This actuator 122 operates under the control of the controller 5.

To improve the speed and efficiency of the discard system, an inclined surface 123 may be provided on the opposite side of the conveyer belt mechanism to the movable arm such that as an edge of packaged product is displaced by the movable arm, an opposing edge of the packaged product is displaced from the opposing belt 15 and moves up the inclined edge 123. This movement causes the other side of the package to fall quickly from the arm 121 into the opening 120.

Another feature which may be used to improve the speed of operation of the discard mechanism 4 is that the movable arm 121 may comprise a means for providing a downward force on an item to increase its displacement downwards through the opening. Using such a mechanism, when a packaged item is pushed by the arm over the opening 120, the means for providing the downward force forcefully pushes the packaged product into the opening. One simple means for providing a downward force is an air blower, which simply comprises an opening through which pressurised air may be directed towards the packaged product. The air blower may be permanently blowing air (wasteful) or may be activated at the same time as the arm. This air blower (not shown) may be fixed to the top edge of the arm.

The discard mechanism may comprise a sensor (not shown) for indicating when the arm has reached its full travel length and thus may be retracted. Moreover, the discard mechanism may comprise a sensor 125 for indicating when a package to be discarded is at the position where the arm may be operated to drop it through the opening. Such a sensor may readily be implemented using any suitable position sensor including a light sensor of the type previously described in relation to the first sensor 21.

The controller 5 accepts a plurality of inputs from different sensors in the inspection system along with a number of user input devices. The inspection system comprises a combination of different sensors.

The controller for the system may be any suitable control circuit or controller, but is advantageously a programmable logic controller (PLC). The PLC accepts a number of inputs from the user and also from the inspection system and other sensors, as shown in FIG. 14. These inputs are taken by suitable software code within the PLC and in turn generate appropriate outputs which are sent to the various actuators of the inspection system including the discard mechanism. These inputs and outputs will now be described in greater detail. In particular, the inputs to the PLC may include inputs from one or more of the following devices:
a keypad 103 through which the user may input commands, for example to place the inspection in a teach mode, start/stop the machine, adjust the control characteristics (e.g. the sensitivity values described above), or to switch on/off test functions e.g. the inlay detection,
a first pattern/colour sensor 26 positioned above the transport mechanism indicating the presence of a reference pattern/colour on the top side of a package,
a second pattern/colour sensor 27 positioned below the transport mechanism for checking the presence of a reference pattern/colour on the top side of a package,
a first position sensor 21 for detecting the arrival of a package in the test location,
a second position sensor 125 for detecting the arrival of a package at the discard mechanism,
an inlay card light sensor 23 for detecting the presence or otherwise of an inlay card in the end of a optical disc case, and
the capacitance measurement system, in practise this will generally provide two inputs 37,38 to the PLC. The first input indicating when the reference capacitance is greater than the measurement capacitor and the second input indicating when the reference capacitance is less than the measurement capacitor.

The outputs from the PLC would typically include outputs for controlling the following devices:
a user display 104 which may display messages to the user, for example the number of packages rejected and the reasons for rejection,
the conveyor belt transport mechanism 2,
the stop actuator 81 for actuating the stop 80 used in the teach mode for halting the progress of the package along the conveyor,
the colour/pattern sensors 26/27_{teach}, although these are sensors are primarily for testing an output is required to tell the sensors to acquire a reference colour\pattern during the teach mode,
the motor 50 for driving the autobalance system for the capacitive measurement system, two outputs are in fact required the first for causing forward motion and the second for reverse motion,
a control signal 140 for the actuator in the control panel enclosure for ejecting a reference package from between the plates of the capacitor through the slot, and
the discard mechanism 4 including the actuator 122 for the arm 121.

It will be appreciated that a variety of other inputs and outputs may be provided to increase the functionality of the system. For example, inputs and outputs may be provided with interlinking production machinery to ensure that in the event of the failure of one piece of apparatus in a production line, the adjoining apparatus are also shut down.

An exemplary method of operation will now be described, shown in FIG. 15 with reference to software implemented within the PLC in conjunction with the inputs and outputs from the previously described. For the purposes of this explanation it is assumed that the system has been taught (as described previously). The method commences with the controller checking 150 for the arrival of a package in the test location, i.e. by checking the status of the first sensor 21. This checking function may be implemented by configuring the input from the first sensor 21 as an interrupt within the PLC, which when triggered activates a sub-routine to perform a package inspection routine.

Once a package arrives, the PLC immediately checks the status of the inlay card sensor input 23 to determine whether an inlay card is present 151.

The PLC then tests 152 the Capacitor and Colour sensor outputs 37,38, 26, 27 for a product pass optionally using the previously described enhanced sensitivity techniques.

If no test failure has been detected the PLC exits the subroutine and waits for the arrival of the next package to be inspected. If a test failure has been detected from any one of the sensors, the PLC reacts to discard the package by waiting for the package to enter the discard mechanism, e.g. by monitoring 155 the second position sensor input 125, and then activating 154 the discard mechanism i.e. by switching on the arm actuator 122. Once the package has been discarded, the PLC may exit the subroutine to await 150 the arrival of the next package into the test location.

The combination of the sensors presented by the system of the present invention is particularly advantageous in that it allows the present system to identify the following problems with the following optical package types.

### CD/DVD/Envelope

Detection of missing disc/discs in Jewel box, Super Jewel box, Brilliant box, Envelope & DVD Softbox.
Detection of double disc/discs in Jewel, Brilliant box, Envelope & DVD Softbox
Misplaced or loose disc.
Damaged disc.

### Booklet

Missing Booklet.
Incorrect booklet
Orientation of booklet upside down or back to front.
Booklet inserted correctly but not far enough or too far.

### Inlay

Missing inlay.
Incorrect inlay.
Orientation of inlay (upside down or back to front).
Inlay inserted correctly.

### Tray

Missing tray
Tray not clipped into duel/brilliant box correctly.
Extra tray.

### DVD Softbox Paperwork

Detection of missing paperwork.
Orientation of inlay (upside down or back to front).

A further significant advantage of the present system is that because a plurality of sensors are used to detect particular faults, it is possible for the control system to identify the types of faults occurring (by virtue of the individual sensor providing the failure signal). The control system may therefore indicate to the user the reason why a particular package has failed. Alternatively, or in addition, the control system may indicate (for example on the user display or by communication with a QA system) a running total of failures to date. Thus an operator may instantly determine potential problems with earlier components of the production line by analysis of the number and types of faults.

Although, the features of the present invention have been described with reference to optical disc packaging, it will be appreciated that the features of the present invention may readily be applied to inspection systems for other types of packaged goods with suitable modification.

The words comprises/comprising when used in this specification are to specify the presence of stated features, integers, steps or components but does not preclude the presence or addition of one or more other features, integers, steps, components or groups thereof.

1. A capacitor sensing inspection system, the system comprising a pair of capacitors, the first capacitor in use having a reference package as a dielectric, the second capacitor in use having a package to be measured as a dielectric, the system having a measurement circuit for providing a first indication when the capacitance of the first capacitor is substantially greater than the capacitance of the second capacitor and a second indication when the capacitance of the first capacitor is substantially less than the capacitance of the second capacitor, the first and second indications being indicative of differences between the reference package and the package to be measured and wherein the system further comprises a potentiometer having a variable position for adjusting a balance point of the measurement circuit so as to equalise a response between the first and second indications,
characterised in that the capacitor system further comprises an auto-balancer for controlling the balance point, wherein upon activation of the auto-balancer, the potentiometer is adapted to be moved into a first position where a first indication is received from the measurement circuit and into a second position where a second indication is received from the measurement circuit, the auto-balancer being then adapted to move the potentiometer position into a position substantially midway between said first and second positions so as to automatically provide a balance point for the measurement circuit.

2. A system according to claim 1, wherein the activation of the auto-balancer is by means of a user operable switch.

3. A system according to claim 1, wherein the auto-balancer comprises a motor coupled to the potentiometer for moving the potentiometer between the first and second positions.

4. An optical disc inspection system, comprising the capacitor sensing system of claim 1.

5. An inspection system comprising the capacitor sensing system of claim 1, the system further comprising:
a transport mechanism for moving at least one package from a start point towards an end point,
a stop movable between an inactivate position and an activate position, wherein in the activate position the stop prevents the progress of items along the conveyor belt from the start point to the end point,
a control system responsive to a user input to place said inspection system in a teach mode,
wherein upon receipt of the user input, the control system activates the stop and upon the exiting of the inspection system from the teach mode causes the stop to move to the inactive position.

6. An inspection system according to claim 5, wherein the control system is adapted to stop the transport mechanism in response to the user input.

7. An inspection system according to claim 6, wherein the control system is adapted to apply a delay between activating the stop and before stopping the transport mechanism.

8. An inspection system according to claim 5, wherein the transport mechanism comprises a conveyor belt system.

9. An inspection system according to claim 8, wherein said conveyor belt system is a twin belt conveyor.

10. An inspection system according to claim 9, wherein axis of motion of the stop is substantially perpendicular to the direction of travel of the conveyor.

11. An inspection system according to claim 9, wherein in the inactivate position, the stop rests below and between the belts of the conveyor system.

12. A capacitor sensing inspection system according to claim 5 wherein the first capacitor is positioned remotely from said transport mechanism.

13. An inspection system according to claim 12, wherein the first capacitor is located in a control panel enclosure of the inspection system.

14. An inspection system according to claim 13, wherein an opening is provided in said control panel enclosure defining a slot for receiving the reference package and wherein a first plate of the first capacitor is disposed on one side of the slot and the second plate of the capacitor is disposed on the opposing side of the slot.

15. An inspection system according to claim 14, wherein the control panel enclosure includes an actuator for ejecting a reference package through the slot opening.

16. An inspection system according to claim 1, further comprising an inspection system for inlay cards in optical disk packages, comprising:
a transport mechanism for moving at least one optical disk package along a longitudinal axis,
a first sensor for identifying the arrival of an optical disk package at a test location along the longitudinal axis,
a second sensor disposed about said test location, the second sensor being a light sensitive sensor having an associated light source and wherein the light sensitive sensor is positioned on one side of the transport mechanism and the light source is positioned on an opposing side of the transport mechanism along an axis which is inclined relative to the longitudinal axis, such that the second sensor is disposed to provide an indication of the presence of an inlay card in an optical disk package when the first sensor identifies the arrival of an optical disk package.

17. An inspection system according to claim 16, further comprising a colour/pattern recognition sensor for testing the correct presence of printed matter on a top and/or bottom surface of a package.

18. An inspection system according to claim 8, further comprising a discard mechanism for the conveyor belt system, the discard mechanism comprising:
an opening for receiving a package, the opening being positioned between the first and second belts,
an arm movable between a rest position external to the conveyor belt system and an active position, such that when the discard mechanism is activated, the arm is moved from the rest position to the active position displacing one of the at least one packages from one of the belts, thus allowing the package to fall through and be discarded through the opening.

19. An inspection system according to claim 18, wherein the arm is movable along an axis transverse to the longitudinal axis.

20. An inspection system according to claim 18, wherein the rest position is adjacent to an external edge of one of the belts.
